(19) United States
(12) Patent Application Publication
(10) Pub. No.: US 2025/0028768 A1
(43) Pub. Date: Jan. 23, 2025

(54) CUSTOMIZING RECIPES GENERATED FROM ONLINE SEARCH HISTORY USING MACHINE-LEARNED MODELS

(71) Applicant: Maplebear Inc., San Francisco, CA (US)

(72) Inventors: Riddhima Sejpal, Dublin, CA (US); Prithvishankar Srinivasan, Seattle, WA (US); Luis Manrique, New York, NY (US)

(21) Appl. No.: 18/776,104

(22) Filed: Jul. 17, 2024

Related U.S. Application Data
(60) Provisional application No. 63/527,788, filed on Jul. 19, 2023.

(51) Int. Cl. G06F 16/9535; G06F 9/451; G06F 16/9538; G06Q 30/0282; G06Q 30/0601

(52) U.S. Cl. CPC G06F 16/9535; G06F 9/451; G06F 16/9538; G06Q 30/0282; G06Q 30/0633

(57) ABSTRACT

An online system performs an inference task in conjunction with the model serving system or the interface system to generate customized recipes for users. The online system identifies a plurality of popular recipes based on historical user search data. The online system uses the collection of popular recipes to generate customized recipes for users based on user data and retailer data. The online system presents a customized recipe to the user, which may include items required to fulfill the recipe, a list of retailers at which the items are available for purchase, and instructions to combine the items. The online system collects user ratings and feedback on customized recipes to calculate a quality score. The online system may use the quality score to rank the customized recipes.

### CROSS-REFERENCE TO RELATED APPLICATIONS

This application claims the benefit of U.S. Provisional Application No. 63/527,788, filed Jul. 19, 2023, which is incorporated by reference herein in its entirety.

### BACKGROUND

An online system is an online platform that provides one or more online services. An example of an online service is allowing users to perform transactions associated with items. The items may represent physical entities stored in a physical location, such as groceries. A user can place an order for purchasing items from participating retailers via the online system, with the shopping being done by a picker. After the personal shopper finishes shopping, the order is delivered to the user's address. The online system may maintain various recipes, with each recipe including one or more items. A user of the online system may review a recipe and add items from the recipe to an order through the online system. The online system allows a user to browse recipes. However, while the online system may provide an abundant assortment of recipes, the recipes provided may not align with a user's specific requirements.

### SUMMARY

In accordance with one or more aspects of the disclosure, a method for an online system performs one or more inference tasks in conjunction with the model serving system or the interface system to generate customized recipes for users. The online system generates a set of recipes based on user search data. The online system further customizes recipes to generate customized recipes for users based on user data and retailer data. The online system presents a customized recipe to the user, which may include items to fulfill the recipe, a list of retailers at which the items are available for purchase, and instructions to combine the items. The online system collects user ratings and feedback on customized recipes to calculate a quality score. The online system may use the quality score to rank the customized recipes.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method for generating a customized recipe for a user, in accordance with some embodiments.

### DETAILED DESCRIPTION

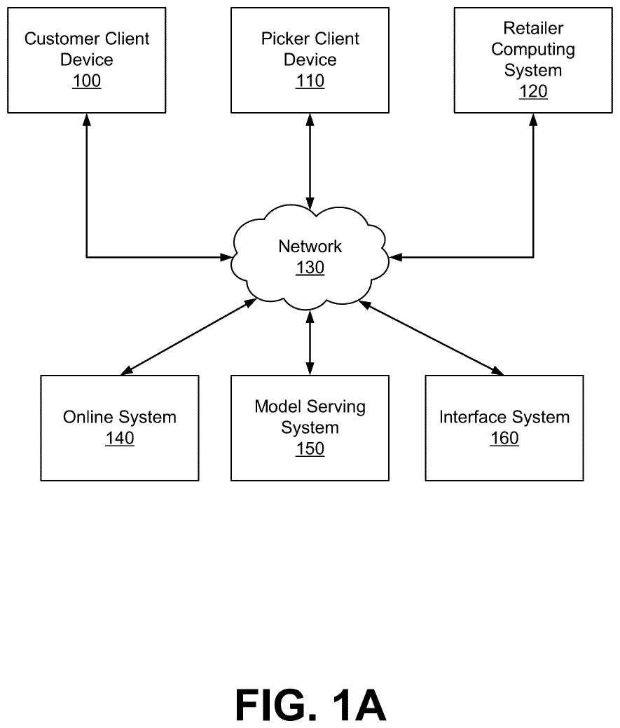

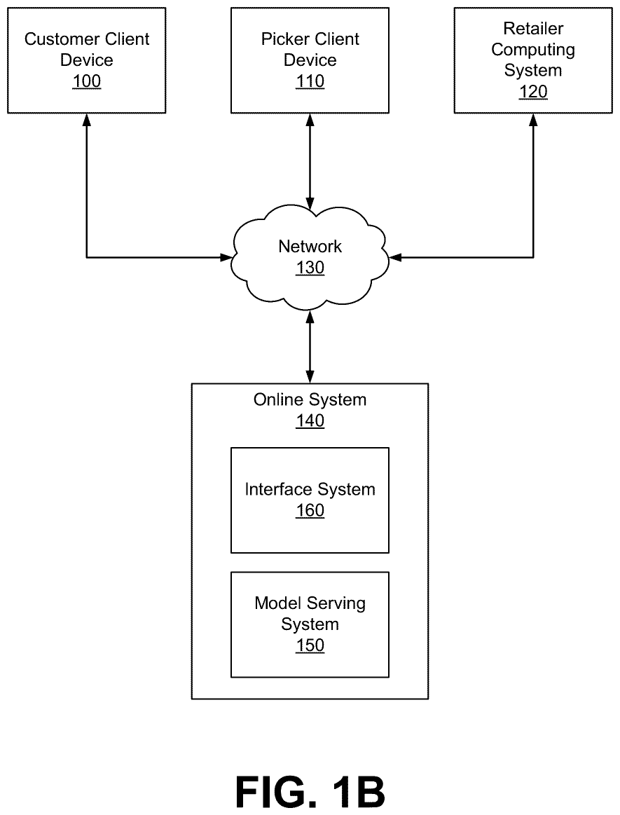

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer ser uto update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

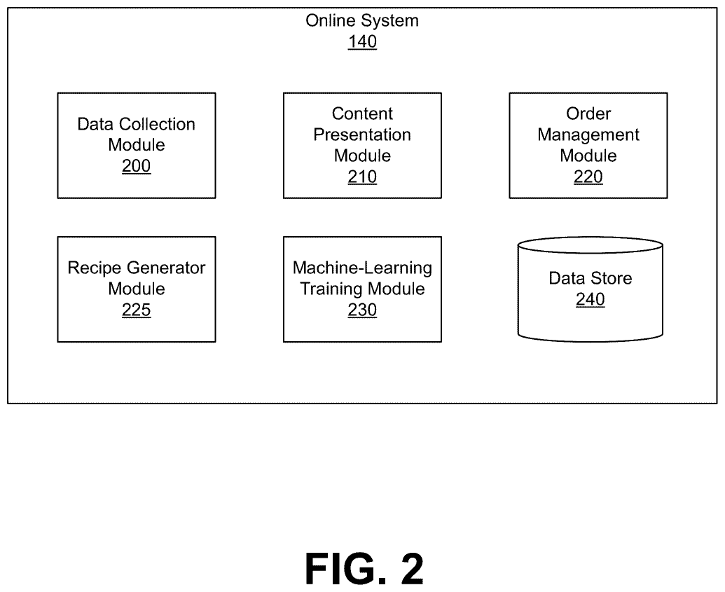

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

In one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one or more instances, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offer data connectors to external data and provide a flexible connector to the external corpus.

One existing issue in recommending recipes to users lies in the struggle to achieve effective personalization and context awareness. Despite advancements, many recommendation systems still fail to deliver tailored suggestions that accommodate individual preferences, dietary needs, cooking skills, cultural backgrounds and inventory availability. These systems often rely on generic recommendations that overlook users' specific tastes and may not sufficiently address diverse dietary restrictions or health-conscious choices. Additionally, recommendations may lack consideration of contextual factors such as meal preparation time, occasion, ingredient availability, and user location. Furthermore, users' cooking skills, cultural preferences, and desires for culinary exploration are frequently overlooked, leading to recommendations that are either too simplistic or too complex. By addressing these challenges, the online system 140 can enhance user satisfaction and engagement by providing more personalized, diverse, and contextually relevant culinary experiences.

In one or more embodiments, the online system 140 generates, customizes, and ranks recipes based on user data and retailer data. The online system 140 generates a collection of popular recipes based on, for example, historical user search data to generate customized recipes for users. For example, the online system 140 analyzes the top twenty thousand recipe related search terms on search engines to determine which dishes are most frequently searched.

The online system 140 may further generate, for one or more users of the online system 140, a plurality of customized recipes based on the collection of recipes. Specifically, the online concierge 140 performs an inference task in conjunction with the model serving system 150 and/or the interface system 160 to generate customized versions of the popular recipes based on user data and retailer data. For each popular dish, the online system 140 constructs a prompt including the dish, other contextual information including user data and retailer data, and a task request to the LLM to generate a customized recipe for the dish based on the preferences and/or the requirements indicated. For example, given an orange chicken dish and a vegetarian user, the online system 140 may generate a recipe which substitutes chicken for tofu. The customized recipes may be displayed to a user through landing webpages or a recipe page within the client application operating on the customer client device 100.

The online system 140 determines a set of relevant recipes for users by selecting a set of highest ranked recipes based on a quality score assigned to each recipe. The online system 140 provides user feedback and ratings of a recipe and a request to calculate a quality score to the model serving system 150. The model serving system 150 applies a machine-learned model to calculate the quality score of the recipe. The quality score allows the online system 140 to rank recipes for each user based on relevancy.

The disclosed method herein uses an LLM to interpret the nuanced context of user queries and preferences, generating personalized recipes tailored to individual tastes, dietary needs, and ingredient availability. The trained machine learned model adapts dynamically to evolving user preferences, ensuring customized recipes remain relevant over time. By integrating contextual information such as mealtime and occasion, LLM-generated recipes are not only personalized but also contextually relevant. LLMs can suggest ingredient substitutions and innovative recipe ideas, enhancing user engagement and satisfaction. Moreover, by integrating a quality score with the LLM model, the online system 140 may customize recipes with dynamic learning and adaptation to user preferences. By continuously refining the customized recipes based on the quality score which is generated based on past interactions and real-time feedback, the disclosed method ensures that customized recipes remain up-to-date and relevant. In this manner, the online system 140 can customize recipes for users based on user data and retailer data, thus allowing for the provision of a seamless end-to-end recipe discovery to recipe preparation journey for users.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a recipe generator module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer user. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one or more instances, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when an order is offered to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The recipe generator module 225 generates a collection of recipes based on historical user search data to generate customized recipes for users. In one or more embodiments, the collection of recipes is generated based on historical search terms or query terms extracted from, for example, search engines. The historical user search data may include search terms obtained from users on the client application operating on the customer client devices 100, or on search engines. In one or more embodiments, the recipe generator module 225 generates and maintains a landing webpage for each of the popular recipes. In some embodiments, the recipe generator module 225 may specifically analyze conversion search terms, which are search terms that resulted in users clicking through to the generated landing webpages of the online system 140. The online system 140 tracks traffic through the landing webpages for one or more recipes and can analyze which search terms were responsible for the traffic coming through a recipe page.

The online system 140 generates the collection of recipes based on the identified set of popular search terms in conjunction with a LLM deployed by the model serving system 150. For example, the prompt to the LLM may include an identified search term (e.g., “orange chicken dish”) and a request to generate a recipe that includes ingredients and instructions for making the dish associated with the search term. This process may be repeated for top search terms (e.g., 100 search terms).

The recipe generator module 225, in conjunction with the model serving system 150, generates, for each user, a plurality of customized recipes based on the collection of recipes. Specifically, the recipe generator module 225 constructs, for each recipe of the collection of recipes, a prompt and a task request to the LLM to generate a customized recipe based on user data and retailer data. User data may include dietary restrictions, nutritional requirements, previous shopping activity, feedback on previously generated customized recipes, cooking ability, etc. Retailer data may include retailer location, inventory items, inventory item levels, etc. An example prompt to the LLM of the model serving system 150 may be:
“Generate a recipe for a [user preference] meal using [inventory items] and considering [dietary restrictions].”
   where [user preference] indicates any specified user preferences for a particular user, [inventory items] describes a list of items available in the inventory of one or more retailers, and [dietary restrictions] describes any dietary restrictions for the particular user. As an example, a user requesting an orange chicken recipe, may have a vegetarian diet.

The recipe generator module 225 may receive a response from the LLM that may include a customized recipe including a list of ingredients and instructions for combining the ingredients according to the requirements indicated.

The recipe generator module 225 may present the customized recipe to the user on a landing webpage or a recipe page on a client application. The landing webpage or recipe page may also display the number of users who cooked or bought items from a particular recipe. The items presented to the user are determined based on item availability at retailers relevant to the user. The LLM may determine a retailer to be relevant to a user based on geographic location (e.g., a user's zip code), or previous activity of the user shopping at the retailer. In addition, the order in which the relevant retailers are presented to the user may be determined based on the user's shopping data. For example, if the user owns a member card for a grocery store, the grocery store may be the first retailer presented to the user on the landing webpage. The recipe generator module calculates a quality score for each recipe using user ratings and feedback, similar to the process described in FIG. 1A.

In one or more embodiments, the recipe generator module 225 can determine, based on the ingredients of the customized recipe, the image of the dish shown in conjunction with the customized recipe. Using the example above in which the online system 140 generates a vegetarian option of an orange chicken recipe for a vegetarian user, the recipe generator module 225 may display an image of an orange tofu dish instead of displaying an image of an orange chicken dish. In one or more embodiments, the image for an LLM-generated recipe may be generated by applying a multi-modal image generation model that takes in a description of the recipe (e.g., ingredients, title of recipe, instructions) as input and outputs an image corresponding to an image of the recipe.

The recipe generator module 225 may repeat this process for other recipes in the collection. Therefore, the recipe generator module 225 collects user feedback, ratings, and reviews for recipes and feeds them into a recommender machine learned model that calculates a quality score for each recipe, improving the recommendation engine. The recipe generator module 225 continually updates and retrains the LLM and the recommender machine learned model based on user feedback and outcome data, ensuring consistent improvements in recipe quality and relevance, as well as enhancing the overall user experience.

The recipe generator module 225 may obtain feedback on the recipes as users of the online system 140 interact with presented recipes. The user feedback, both explicit (e.g., ratings, likes) and implicit (e.g., click-through rates, time spent), may be collected. In one instance, the recipe generator module 225 may calculate a quality score for a recipe based on user feedback, ratings, and reviews. For example, the recipe generator module 225 may collect numerical ratings provided by users along with textual reviews and other forms of feedback, preprocess the collected data, such as normalizing ratings to a consistent scale and conducting sentiment analysis on textual reviews to determine their polarity. As recipes are presented to users and feedback is collected from users, the recipe generator module 225 uses the quality scores to identify whether recipes should be presented to subsequent user sessions.

In one or more embodiments, the recipe generator module 225 may obtain a training data set including a set of training examples. A training example may include a historic prompt and an output that was known to have positive (implicit or explicit) feedback from the user. For example, a training example may include a prompt to request customization of a recipe as described above, and the known output may be the resulting recipe that the user resulted in clicking or converting on the items that were ingredients of the customized recipe. The recipe generator module 225 fine tunes parameters of the LLM deployed by model serving system 150 based on the set of training examples. Specifically, the recipe generator module 225 inputs the prompts to the LLM to generate estimated outputs. A loss function between the estimated outputs and the known outputs are computed. One or more error terms obtained from the loss function are backpropagated to update the parameters of the LLM.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data. The data store 240 stores the identified recipes, the user preference, dietary restrictions, etc. The stored recipes may be used to train one or more machine learning models. The user preference and dietary restriction may be used to provide contextual information to customize recipes for users.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

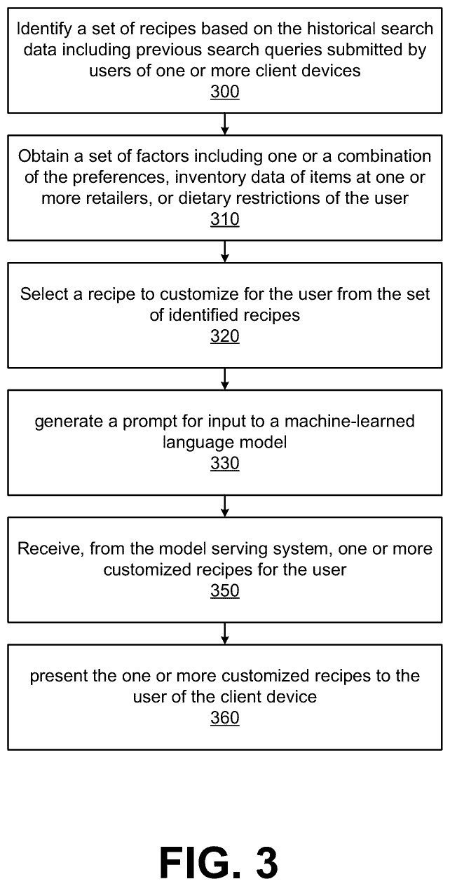

FIG. 3 is a flowchart for a method for generating a customized recipe for a user, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140).

The online system 140 identifies 300 a set of recipes based on the historical search data including previous search queries submitted by users of one or more client devices. In one or more embodiments, the online system 140 collects historical search data, including previous search queries submitted by users, along with metadata such as timestamps, user identifiers, and contextual information. The online system 140 may store the collected data in a structured format in a database. In some implementations, the online system 140 may pre-process the collected data such as cleaning the data to remove noise and irrelevant information, performing tokenization to break down search queries into manageable units, and performing normalization to standardize text. The online system 140 analyzes the historical search data to identify patterns, trends, and relationships between search queries and recipes. For example, the online system 140 may identify frequent search terms, popular ingredients, common combinations, and user preferences by analyzing the frequency of occurrence and correlations between different search queries. The online system 140 stores the identified set of recipes in the data store 240. The online system 140 generates a collection of recipes based on a set of popular search terms identified from the search data.

The online system 140 obtains 310, for a user of an online system 140, a set of factors including one or a combination of the preferences of the user, inventory data of items at one or more retailers for the user based on geographical location, or dietary restrictions of the user. For example, the online system 140 may prompt the users to share their culinary preferences, dietary restrictions, favorite cuisines, and cooking habits during the registration process or through optional surveys. The online system 140 may request/analyze user interaction such as search queries, recipe views, likes, ratings, and comments to obtain individual preferences and interests. In one or more embodiments, the online system 140 may access inventory information from various retailers. For example, users may choose to link their accounts from specific retailers, granting the system access to their purchase history and current inventory. Alternatively, users can manually input information about items in their pantry or shopping list. This data allows the system to suggest recipes based on available ingredients and streamline the shopping experience by providing relevant product recommendations. In some implementations, the online system 140 may obtain information about user dietary restrictions and preferences, for example, during registration or through profile settings, including allergies, intolerances, religious dietary requirements, or lifestyle choices like vegetarianism or veganism. When performing searches or filtering recipes, users may specify their dietary restrictions, which the online system uses to exclude or prioritize recipes accordingly.

The online system further selects 320 one or more recipes to customize for the user from the set of identified recipes. In one or more embodiments, the online system 140 may select the recipe based on a user's preferences, dietary restrictions, ingredient availability, and contextual information. For example, the online system 140 may use a machine learning model to select the recipe. In some implementations, the online system 140 analyzes the user's culinary preferences, including preferred cuisine types, cooking skill level, and any dietary restrictions such as allergies or vegetarianism. The online system 140 may filter the set of recipes based on these criteria, e.g., by excluding recipes with incompatible ingredients and prioritizing those aligning with the user's tastes. In one or more embodiments, the online system 140 determines ingredient availability, for example, by accessing the user' inventory data or integrating with retailers, to ensure the user can access necessary ingredients.

The online system generates 330 a prompt for input to a machine-learned language model. The prompt may specify the selected recipes, the set of factors including one or a combination of the preferences of the user, the inventory data, and a request to generate a customized recipe for the user. In one or more embodiments, the prompt may include various contextual information, for example, time of year, special occasions, event theme, etc. In one example, a prompt to the LLM of the model serving system may be:
“Customize a recipe for a summertime salad using at least summer seasonal fruits and white meat and considering glucose intolerance.”

The online system provides 340 the prompt to a model serving system 150 for execution by the machine-learned language model for execution. The online system 140 receives 350 from the model serving system, one or more customized recipes for the user. The customized recipe is generated by executing the machine-learned language model on the prompt. Following the above example, the customized recipe may be:
“Grilled Chicken and Summer Fruit Salad with Citrus Vinaigrette
Ingredients:
For the salad:
2 boneless, skinless chicken breasts
2 cups mixed salad greens (such as spinach, arugula, and romaine)
1 cup cubed watermelon
½ cup blueberries
¼ cup sliced almonds, toasted
¼ cup crumbled feta cheese (optional)
2 tablespoons freshly squeezed lemon juice
. . .
Instructions:
   1. Prepare the chicken . . . ”

The online system 140 presents 360 the one or more customized recipes to the user of the client device. In one or more embodiments, the online system 140 may first apply a recommendation machine-learned model to the customized recipes to rank the recipes based on relevance. The recommendation machine-learned model may generate a quality score for each recipe and the online system 140 may select a subset of recipes that have the highest quality scores for presentation to the user. In some implementations, the online system 140 may compare the quality scores to a predetermined threshold, and select recipes having a quality score that exceeds the predetermined threshold. The online system 140 may rank the subset of recipes based on their corresponding qualities scores and select one or more recipes based on their ranking positions (e.g., top 1, top 5, etc.) for presentation to the user. The recommendation machine-learned model may be trained by obtaining a plurality of recipes and corresponding quality scores for the plurality of recipes, applying the recommendation machine-learned model to the plurality of recipes to generate estimated outputs, and updating parameters of the recommendation machine-learned model based on a loss function indicating a difference between the estimated outputs and the quality scores for the plurality of recipes.

In one or more embodiments, the online system 140 may present the selected recipes to the user on a landing webpage or a recipe page on a client application. The landing webpage or recipe page may also display the number of users who cooked or bought items from a particular recipe. In one or more embodiments, the landing page or recipe page on the client application may include a user interface. The user interface may include a set of interactable user interface elements. Each interactable user interface element may correspond to a component of a customized recipe, e.g., “ingredients,” “instructions,” etc. In some implementations, each of the ingredients and/or instruction steps may be presented in a user interface element. For example, “1 cup cubed watermelon” may be presented in a user interface element. When a user performs an interactive action with (e.g., clicks, tabs, hovers, etc.) the user interface element, the online system 140 may cause the user interface to only display additional information related to the interacted item, e.g., calories contained in the “1 cup cubed watermelon.” The interface may also include a button when clicked by the user, presents an ordering interface including a set of items to order at one or more retailers that correspond to the ingredients in a recipe.

In one or more embodiments, the positions of the interactable user interface elements may be determined based on the users' historical interactive actions with the user interface elements, such as, users' click rate, interaction frequency, interaction time intervals etc. For example, more frequently interacted interactable user interface elements may be moved to a more prominent position, e.g., the first position in the list. The online system 140 may rank the interface elements based on each interface element's interaction history, such as rate, frequency, time interval, etc., and arrange the positions of the interface elements in the user interface based on each interface element's ranking position.

In one or more embodiments, the online system 140 may remove/hide/fold a user interface element that is less frequently interacted by a user. For example, a user never interacts/clicks the “instructions.” The online system 140 may display the steps in the instruction from being fully displayed to partially displayed interface elements, e.g., bullet points. When the user interacts with a bullet point, e.g., “prepare the chicken,” the bullet item may expand to show detailed steps of the instruction, such as “season the chicken breasts with salt and pepper . . . .” In one or more embodiments, the position of the interactable user interface elements may be customized to meet a specific user's need/preference. In some implementations, the online system 140 may present the customized recipe to the user, which may include items required to fulfill the recipe, a list of retailers at which the items are available for purchase, and instructions to combine the items. Each item/retailer may be displayed as an interactable user interface element such that when the user interacts with the user interface element, the corresponding item/retailer may be selected, removed, automatically added to shopping cart, etc. In some examples, the user interface may include an “automatic” function, when activated, one or more default/recommended items may be automatically added into the shopping cart.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
generating a set of recipes based on search data including previous search queries submitted by users;
obtaining, for a user of an online system, a set of factors including at least one of preferences of the user, inventory data of items at one or more retailers for the user, or dietary restrictions of the user;
selecting, from the set of recipes, a recipe to customize for the user;
generating a prompt for input to a machine-learned language model, the prompt specifying at least the obtained set of factors for the user and a request to customize the recipe for the user;
providing the prompt to a model serving system for execution by the machine-learned language model for execution; and
receiving, from the model serving system, a customized recipe for the user generated by executing the machine-learned language model on the prompt; and
sending instructions that cause a client device to display the customized recipe for display on a webpage or an application page to the user of the client device.

2. The method of claim 1, further comprising identifying a list of items required to fulfill the customized recipe, and wherein the list of items is identified based on a retailer for the user.

3. The method of claim 1, further comprising:
requesting a rating for the customized recipe from the user; and
generating a quality score for the customized recipe based at least on a received rating from the user.

4. The method of claim 3, further comprising:
updating the machine-learned language model by using the quality score as a reward signal.

5. The method of claim 1, further comprising:
applying a second machine-learned model to a subset of recipes including the customized recipe to generate a set of quality scores;
ranking the subset of recipes based on the respective quality score of each recipe; and
providing one or more recipes for display to the client device based on the ranking.

6. The method of claim 5, wherein the second machine-learned model is trained by performing steps of:
obtaining a plurality of recipes and corresponding quality scores for the plurality of recipes;
applying the second machine-learned model to the plurality of recipes to generate estimated outputs; and
updating parameters of the second machine-learned model based on a loss function indicating a difference between the estimated outputs and the quality scores for the plurality of recipes.

7. The method of claim 1, wherein presenting the customized recipe to the user of the client device comprises:
causing the client device to display the customized recipe on a user interface, wherein each ingredient in the customized recipe is displayed in an interactable user interface element in the user interface.

8. A computer program product comprising a non-transitory computer readable storage medium having instructions encoded thereon that, when executed by a processor, cause the processor to perform steps comprising:
generating a set of recipes based on search data including previous search queries submitted by users;
obtaining, for a user of an online system, a set of factors including at least one of preferences of the user, inventory data of items at one or more retailers for the user, or dietary restrictions of the user;
selecting, from the set of recipes, a recipe to customize for the user;
generating a prompt for input to a machine-learned language model, the prompt specifying at least the obtained set of factors for the user and a request to customize the recipe for the user;
providing the prompt to a model serving system for execution by the machine-learned language model for execution; and
receiving, from the model serving system, a customized recipe for the user generated by executing the machine-learned language model on the prompt; and
sending instructions that cause a client device to display the customized recipe for display on a webpage or an application page to the user of the client device.

9. The computer program product of claim 8, wherein the steps further comprise identifying a list of items required to fulfill the customized recipe, and wherein the list of items is identified based on a retailer for the user.

10. The computer program product of claim 8, wherein the steps further comprise:
requesting a rating for the customized recipe from the user; and
generating a quality score for the customized recipe based at least on a received rating from the user.

11. The computer program product of claim 10, wherein the steps further comprise:
updating the machine-learned language model by using the quality score as a reward signal.

12. The computer program product of claim 8, wherein the steps further comprise:
applying a second machine-learned model to a subset of recipes including the customized recipe to generate a set of quality scores;
ranking a subset of recipes based on the respective quality score of each recipe; and
providing one or more recipes for display to the client device based on the ranking.

13. The computer program product of claim 12, wherein the second machine-learned model is trained by performing steps of:
obtaining a plurality of recipes and corresponding quality scores for the plurality of recipes;
applying the second machine-learned model to the plurality of recipes to generate estimated outputs; and
updating parameters of the second machine-learned model based on a loss function indicating a difference between the estimated outputs and the quality scores for the plurality of recipes.

14. The computer program product of claim 8, wherein the steps of presenting the customized recipe to the user of the client device comprise:
causing the client device to display the customized recipe on a user interface, wherein each ingredient in the customized recipe is displayed in an interactable user interface element in the user interface.

15. A computer system comprising:
a processor; and
a non-transitory computer-readable storage medium having instructions that, when executed by the processor, cause the computer system to perform steps comprising:
generating a set of recipes based on search data including previous search queries submitted by users;
obtaining, for a user of an online system, a set of factors including at least one of preferences of the user, inventory data of items at one or more retailers for the user, or dietary restrictions of the user;
selecting, from the set of recipes, a recipe to customize for the user;
generating a prompt for input to a machine-learned language model, the prompt specifying at least the obtained set of factors for the user and a request to customize the recipe for the user;
providing the prompt to a model serving system for execution by the machine-learned language model for execution; and
receiving, from the model serving system, a customized recipe for the user generated by executing the machine-learned language model on the prompt; and
sending instructions that cause a client device to display the customized recipe for display on a webpage or an application page to the user of the client device.

16. The system of claim 15, wherein the steps further comprise identifying a list of items required to fulfill the customized recipe, and wherein the list of items is identified based on a retailer for the user.

17. The system of claim 15, wherein the steps further comprise:
requesting a rating for the customized recipe from the user; and
generating a quality score for the customized recipe based at least on a received rating from the user.

18. The system of claim 15, wherein the steps further comprise:
applying a second machine-learned model to a subset of recipes including the customized recipe to generate a set of quality scores;
ranking a subset of recipes based on the respective quality score of each recipe; and
providing one or more recipes for display to the client device based on the ranking.

19. The system of claim 18, wherein the second machine-learned model is trained by performing steps of:
obtaining a plurality of recipes and corresponding quality scores for the plurality of recipes;
applying the second machine-learned model to the plurality of recipes to generate estimated outputs; and
updating parameters of the second machine-learned model based on a loss function indicating a difference between the estimated outputs and the quality scores for the plurality of recipes.

20. The system of claim 15, wherein the steps of presenting the customized recipe to the user of the client device comprise:
causing the client device to display the customized recipe on a user interface, wherein each ingredient in the customized recipe is displayed in an interactable user interface element in the user interface.
